(19) United States
(12) Patent Application Publication
(10) Pub. No.: US 2023/0071947 A1
(43) Pub. Date: Mar. 9, 2023

(54) INFORMATION PROCESSING SYSTEM, INFORMATION PROCESSING METHOD, PROGRAM, AND USER INTERFACE

(71) Applicant: SONY GROUP CORPORATION, TOKYO (JP)

(72) Inventor: KOHEI MIYAMOTO, TOKYO (JP)

(21) Appl. No.: 17/756,052

(22) PCT Filed: Nov. 10, 2020
(86) PCT No.: PCT/JP2020/041907

§ 371 Date: Nov. 17, 2022

(30) Foreign Application Priority Data
Nov. 25, 2019 (JP) 2019-212621

(51) Int. Cl. G06T 11/00

(52) U.S. Cl. CPC G06T 11/00; G06T 2200/24

(57) ABSTRACT

An information processing system (1) includes a blend shape parameter acquisition unit (11), a correction parameter acquisition unit (12), and a face generation unit (13). The blend shape parameter acquisition unit (11) acquires a weight of a blend shape model (BSM) to be blended with a base model (BM) as a blend shape parameter (a). The correction parameter acquisition unit (12) acquires a magnitude of a correction factor (CF) that affects an expression of the blend shape model (BSM) as a correction parameter (β). The face generation unit (13) corrects a transformation (P) between the base model (BM) and the blend shape model (BSM) on the basis of a correction equation (M) associated with the correction factor (CF) and the blend shape model (BSM) and generates a face of a character using the corrected transformation (P^{c}), the blend shape parameter (α), and the correction parameter (β).

### FIELD

The present invention relates to an information processing system, an information processing method, a program, and a user interface.

### BACKGROUND

Blend shape is known as a method for controlling an expression of a computer graphics (CG) character. The blend shape is a method for generating any desired expression by blending an expression model (blend shape model) such as “smile”, “cry”, or “anger” with an expression model (base model) of a base character.

In order to control the expression of the character, it is common to control a Facial Action Coding System (FACS) compliant parameter or an expression parameter (a parameter higher in abstraction level than FACS, such as a smiling face or a sad face) assigned to the blend shape. This method puts a heavy burden on a creator responsible for adjusting such a parameter. Therefore, a method for modeling a face of a character using a combination of blend shape and principal component analysis (PCA) has been proposed (for example, Patent Literature 1).

Under the method disclosed in Patent Literature 1, a PCA-based parameter control model is converted into a face control parameter on the basis of a semantic description of the face and a related measurement criterion rather than deforming the face using the PCA-based parameter control model as it is (a model formed of each principal component axis has no meaning). This allows a PCA-based parameter control model that is high in abstraction level to be used as a human-understandable parameter.

### CITATION LIST

### Patent Literature

Patent Literature 1: JP 2014-522057 A

### SUMMARY

### Technical Problem

However, the above-described technique in the related art requires a creator to prepare a measurement criterion for face control parameters. It is therefore difficult to prepare, for example, a face controller that affects various abstract expressions such as a mood. Further, the face control parameters do not affect each other, and the expression of the character is generated as a simple linear sum of a plurality of blend shape models. It is therefore difficult to collectively correct some or all of the face control parameters with reference to a mood or the like.

The present disclosure proposes an information processing system, an information processing method, a program, and a user interface capable of reducing a burden on a creator responsible for correcting an expression of a character.

### Solution to Problem

According to the present disclosure, an information processing system is provided that comprises: a blend shape parameter acquisition unit that acquires a weight of a blend shape model to be blended with a base model as a blend shape parameter; a correction parameter acquisition unit that acquires a magnitude of a correction factor that affects an expression of the blend shape model as a correction parameter; and a face generation unit that corrects a transformation between the base model and the blend shape model on the basis of a correction equation associated with the correction factor and the blend shape model and generates a face of a character using the transformation corrected, the blend shape parameter, and the correction parameter. According to the present disclosure, an information processing method in which an information process of the information processing system is executed by a computer, and a program for causing the computer to execute the information process of the information processing system, are provided.

According to the present disclosure, a user interface is provided that comprises: a blend shape parameter input field where a list of a plurality of expression models is displayed; a correction parameter input field where a list of a plurality of model factors is displayed; and a preview area where a face of a character is displayed, the face being generated on the basis of at least one expression model selected in the blend shape parameter input field and at least one model factor selected in the correction parameter input field, wherein each of the plurality of model factors affects an expression of at least one expression model among the plurality of expression models, and at least one expression model whose expression is affected by the at least one model factor selected in the correction parameter input field among the plurality of expression models displayed in the blend shape parameter input field is highlighted.

### BRIEF DESCRIPTION OF DRAWINGS

FIG. 1 is a diagram illustrating an outline of face generation processing.

FIG. 2 is a diagram illustrating a plurality of correction models derived from the same blend shape model.

FIG. 3 is a diagram illustrating an example of a face model used in blend shape.

FIG. 4 is a diagram illustrating an example of a hardware configuration of an information processing system according to a first embodiment.

FIG. 5 is a diagram illustrating an example of a functional configuration of the information processing system.

FIG. 6 is a diagram illustrating an example of a data structure of correction data.

FIG. 7 is a diagram illustrating an example of how to perform the face generation processing via a user interface.

FIG. 8 is a flowchart illustrating an information processing method applied to the face generation processing.

FIG. 9 is a diagram illustrating an example of how to perform correction equation generation processing via a user interface.

FIG. 10 is a flowchart illustrating an information processing method applied to the correction equation generation processing.

FIG. 11 is a diagram illustrating an example of a user interface according to a second embodiment.

FIG. 12 is a diagram illustrating a modification of a correction factor.

### DESCRIPTION OF EMBODIMENTS

Hereinafter, embodiments of the present disclosure will be described in detail with reference to the drawings. Note that, in each of the following embodiments, the same components are denoted by the same reference numerals to avoid the description from being redundant.

Note that the description will be given in the following order.

[1. Outline]

2. First Embodiment

[2-1. Configuration of information processing system]

[2-2. User interface]

[2-2-1. User interface for face generation processing]

[2-2-2. Face generation processing flow]

[2-2-3. User interface for correction equation generation processing]

[2-2-4. Correction equation generation processing flow]

3. Second Embodiment

[4. Modification of correction factor]

[5. Effects]

### 1. Outline

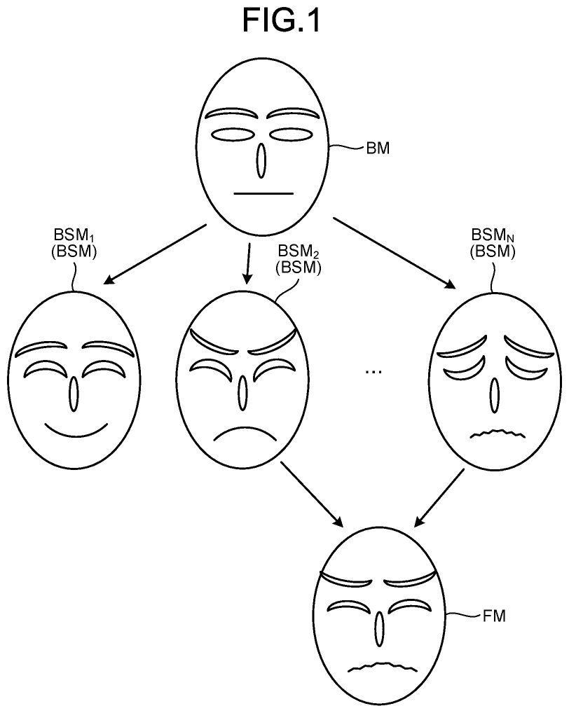

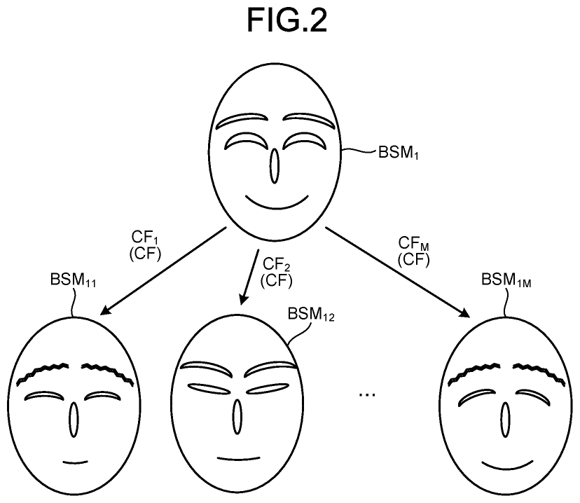

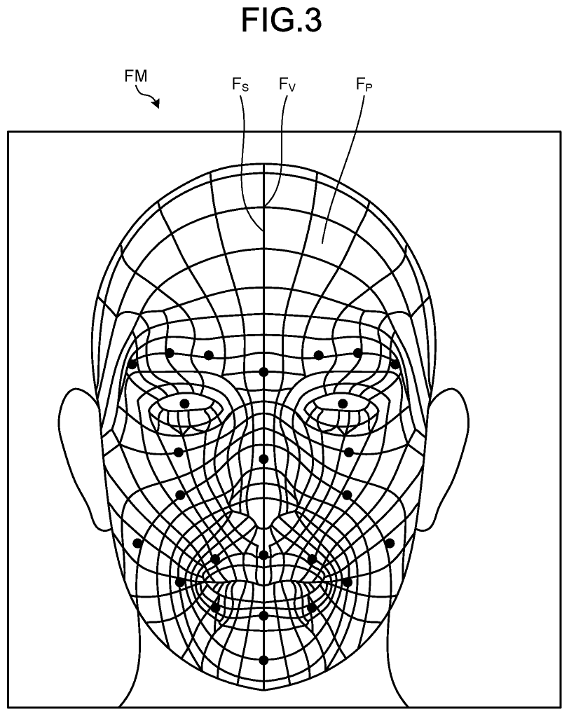

FIG. 1 is a diagram illustrating an outline of face generation processing. FIG. 2 is a diagram illustrating a plurality of correction models derived from the same blend shape model. FIG. 3 is a diagram illustrating an example of a face model used in blend shape.

As illustrated in FIG. 1, in order to generate a face of a character, one base model BM and a plurality of blend shape models BSM are prepared first. The base model BM is a face model serving as a base. An expression of the base model BM is not limited to any specific expression, but the base model BM is generally expressionless. The blend shape model BSM is a face model (expression model) representing an expression different from the expression of the base model BM. Examples of the expression of the blend shape model BSM include a plurality of expressions having different properties such as a smiling face, an angry face, and a crying face.

The base model BM and the blend shape model BSM are created by general-purpose CG software. As illustrated in FIG. 3, a face FM is formed of a polygon mesh including a plurality of vertices F_{V}, and a plurality of sides F_{S} and a plurality of planes F_{P} obtained by connecting adjacent vertices F_{V}.

Various expressions are generated through adjustments to the weights of the plurality of blend shape models BSM to be blended with the base model BM. Specifically, in the example illustrated in FIG. 1, N (N is an integer equal to or greater than 2) blend shape models BSM (BSM₁, BSM₂, . . . , BSM_{N}) are prepared. For example, the blend shape model BSM₁ is a smiling face. The blend shape model BSM₂ is an angry face. The blend shape model BSM_{N} is a crying face. Blending, with the base model BM, the blend shape model BSM₂ and the blend shape model BSM_{N} with a predetermined weight generates the face FM illustrated in FIG. 1. The face FM is an intermediate face between an angry face and a crying face.

The base model BM and the blend shape model BSM are each defined by, for example, a matrix including information on coordinates of each vertex F_{V} of the polygon mesh. An arbitrary face FM is generated using the following equation (1).

$$\begin{matrix}[ Equation 1 ] & \\ X = {X}_{0} + {\sum }_{i = 1}^{n} {α}_{i} {P}_{i} & ( 1 )\end{matrix}$$

$${P}_{i} = {X}_{i} - {X}_{0}$$

X denotes a matrix representing the face FM. X₀ denotes a matrix representing the base model BM. n (n is an integer from 1 to N, both inclusive) denotes the number of blend shape models BSM to be blended with the base model BM. Xᵢ (i is an integer from 1 to n, both inclusive) denotes a matrix representing the i-th blend shape model BSMᵢ. αᵢ denotes a blend shape parameter indicating the weight of the i-th blend shape model BSMᵢ to be blended with the base model BM. Pᵢ denotes a transformation between the base model BM and the i-th blend shape model BSMᵢ. Pᵢ denotes, for example, a matrix including information on a difference between the coordinates of each vertex F_{V} of the polygon mesh of the base model BM and the coordinates of each vertex F_{V} of the polygon mesh of the i-th blend shape model BSMᵢ.

As shown in the equation (1), the arbitrary face model FM is obtained as a weighted linear sum of the plurality of blend shape models BSM. A user can flexibly control the expression of the character by suitably adjusting the values of a plurality of blend shape parameters α (α₁ to α_{N}). The smiling face (blend shape model BSMᵢ) to be expressed, however, includes various types of smiling faces depending on a mood or the like that are collectively referred to as a smiling face as illustrated in FIG. 2, for example. For example, a smiling face (correction model BSM₁₁) when feeling a depressed mood, a smiling face (correction model BSM₁₂) when feeling frustrated, and a smiling face (correction model BSM_{1M}) when feeling tired are slightly different from each other. Therefore, according to the present embodiment, the transformation P (P₁ to P_{N}) is corrected on the basis of a correction factor CF such as a mood as described later.

The blend shape model BSM is a model representing the expression of the character such as smiling, crying, or angry. The expression is a change appearing on a face in response to an emotion or the like. In psychology, an emotion and a mood are distinguished from each other. The emotion is a strong feeling caused by a clear factor, accompanied by physiological excitement such as fear, anger, or joy and typically lasts for a short period of time. A feeling weaker than the emotion is referred to as a mood. The mood is not necessarily a conscious feeling, and may be caused by an unclear factor. As for the mood, there is no significant change in feeling, but the mood last longer than the emotion. The mood itself does not significantly change the shape of a face, but changes the ease of appearance of a feeling on the face.

The correction factor CF is not limited to such a mood. Examples of the correction factor CF include an expression tendency unique to the character (habit appearing in expressing a feeling). A habit appearing in expression such as either of the left and light corners of a mouth being easily raised may widely affect various expressions such as smiling, crying, and angry.

The expression of the character can be embodied by a combination of the plurality of blend shape models BSM and the plurality of correction factors CF. The plurality of blend shape models BSM and the plurality of correction factors CF are suitably combined to generate a realistic expression reflecting subtle movement in the mind of the character.

### 2. First Embodiment

[2-1. Configuration of Information Processing System]

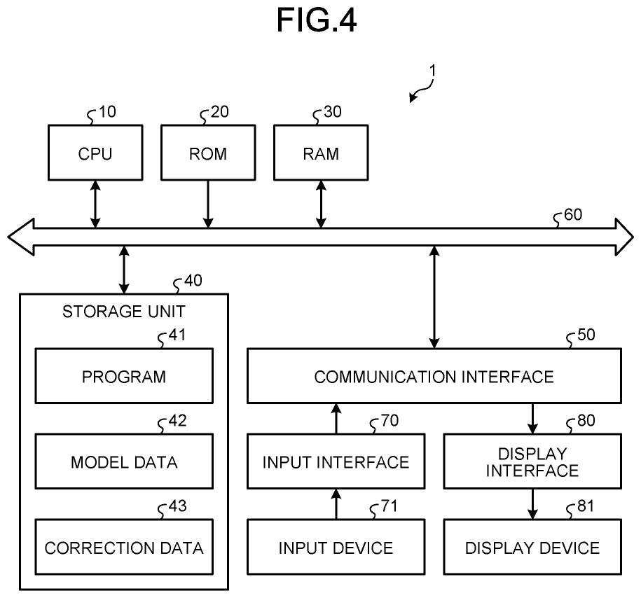

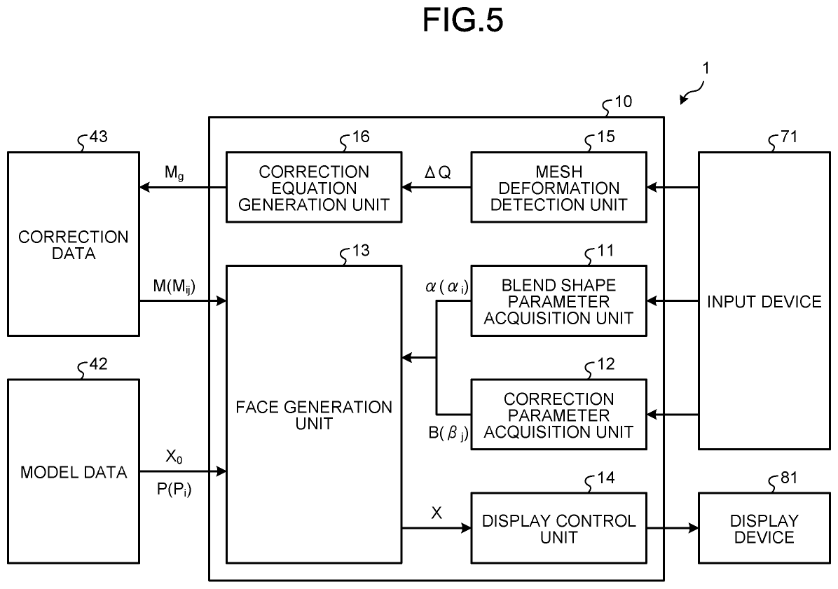

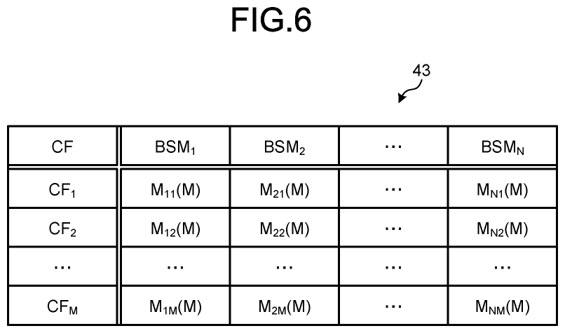

FIG. 4 is a diagram illustrating an example of a hardware configuration of an information processing system 1 according to the first embodiment. FIG. 5 is a diagram illustrating an example of a functional configuration of the information processing system 1. FIG. 6 is a diagram illustrating an example of a data structure of correction data 43.

As illustrated in FIG. 4, the information processing system 1 includes a central processing unit (CPU) 10, a read only memory (ROM) 20, a random access memory (RAM) 30, a storage unit 40, a communication interface 50, an input interface 70, a display interface 80, an input device 71, and a display device 81. The information processing system 1 has a topology where the CPU 10, the ROM 20, the RAM 30, the storage unit 40, and the communication interface 50 are connected to each other over an internal bus 60.

The CPU 10 controls the entire operation of the information processing system 1 in accordance with a program 41 loaded from the storage unit 40 or the ROM 20 onto the RAM 30 and executed. The information processing system 1 operates in accordance with the program 41. The program 41 may be provided to the information processing system 1 over a wired or radio transmission medium such as a local area network, the Internet, or digital satellite broadcasting. The program 41 executed by the CPU 10 may be a program causing processing to be performed on a time-series basis in the order described in the present disclosure, or alternatively may be a program causing processing to be performed in parallel or at required timing such as when a call is made.

The storage unit 40 stores, for example, the program 41 to be executed by the CPU 10 and various pieces of data such as model data 42 and the correction data 43. The storage unit 40 may be used as a work area for temporarily storing a processing result of the CPU 10. Examples of the storage unit 40 include any non-transitory storage media such as a semiconductor storage medium and a magnetic storage medium. The storage unit 40 includes, for example, an optical disc, a magneto-optical disk, or a flash memory. The program 41 is stored in, for example, a non-transitory computer-readable storage medium.

As illustrated in FIG. 5, the model data 42 includes data of a matrix X₀ representing a base model BM and data of a plurality of transformations P each used for transformation between the base model BM and a plurality of blend shape models BSM. According to the present embodiment, for example, N blend shape models BSMs are set. Therefore, the model data 42 includes N transformations Pᵢ (i=1 to N) corresponding to the N blend shape models BSM. The model data 42 may include data of a plurality of matrices Xᵢ to XN each representing a corresponding one of the plurality of blend shape models BSM.

The correction data 43 includes data of a plurality of correction factors CF and data of a plurality of correction equations M. The correction data 43 has a data structure where the correction factor CF, the transformation P, and the correction equation M are associated with each other. In the example illustrated in FIG. 6, M (M is an integer equal to or greater than 2) correction factors CF₁ to CF_{N} are stored as the plurality of correction factors CF. Each correction factor CF is, for example, a mood of a character. The mood is a subtle and continuous feeling about mind and body, or a slightly vague state of mind and body that lasts for a certain period of time. For example, the correction factor CF₁ represents a depressed mood. The correction factor CF₂ represents a state of being frustrated. The correction factor CF_{N} represents a state of being tired.

When the correction factor CF₁ exists, the transformation Pᵢ (i=1 to N) used for transformation between the base model BM and the blend shape model BSMᵢ (i=1 to N) is corrected by the correction equation Mᵢ₁ (i=1 to N). When the correction factor CF₂ exists, the transformation Pᵢ (i=1 to N) is corrected by the correction equation Mᵢ₂ (i=1 to N). When the correction factor CF₃ exists, the transformation Pᵢ (i=1 to N) is corrected by the correction equation Mᵢ₃ (i=1 to N). The storage unit 40 stores, for each correction factor CF, at least one blend shape model BSM affected by the correction factor CF and at least one correction equation M used for correcting at least one transformation P corresponding to the at least one blend shape model BSM with the at least one blend shape model BSM and the at least one correction equation M associated with each other.

The various pieces of data such as the model data 42 and the correction data 43 may be downloaded from an external server (not illustrated) connected to the information processing system 1 over the Internet or the like as necessary and stored in the storage unit 40.

Returning to FIG. 4, the communication interface 50 acquires information input by the input device 10 via the input interface 70. Examples of the input device 10 include various input devices such as a keyboard, a mouse, and a touchscreen. The communication interface 50 causes the display device 81 to display image information or video information via the display interface 80. The display device 81 is, for example, a liquid crystal display panel or an organic EL panel, but the display device 81 is not limited to such a panel. The communication interface 50 communicates with the external server (not illustrated) or the like by radio communication or wired communication. This allows the information processing system 1 to receive various pieces of data such as newly created model data 42 and correction data 43 and to transmit data such as a generated face of a character to the outside.

As illustrated in FIG. 5, the CPU 10 includes a blend shape parameter acquisition unit 11, a correction parameter acquisition unit 12, a face generation unit 13, a display control unit 14, a mesh deformation detection unit 15, and a correction equation generation unit 16. The CPU 10 loads the program 41 onto the RAM 30 and executes the program 41 to act as the blend shape parameter acquisition unit 11, the correction parameter acquisition unit 12, the face generation unit 13, the display control unit 14, the mesh deformation detection unit 15, and the correction equation generation unit 16.

The blend shape parameter acquisition unit 11 acquires the weight of the blend shape model BSM to be blended with the base model BM as the blend shape parameter α. When the number of blend shape models BSM to be blended with the base model BM is n (n is an integer from 1 to N, both inclusive), the blend shape parameter acquisition unit 11 acquires n blend shape parameters αᵢ (i=1 to n) each indicating the weight of a corresponding one of the n blend shape models BSMᵢ (i=1 to n). The blend shape parameter α is input by the input device 71.

The correction parameter acquisition unit 12 acquires the magnitude of the correction factor CF that affects the expression of the blend shape model BSM as a correction parameter β. When the number of correction factors CF is k (k is an integer equal to or greater than 1), the correction parameter acquisition unit 12 acquires k correction parameters βⱼ (j=1 to k) indicating the magnitude of a corresponding one of the k correction factors CF.

The face generation unit 13 corrects the transformation Pᵢ (i=1 to n) between the base model BM and the blend shape model BSMᵢ (i=1 to n) on the basis of the correction equation Mᵢⱼ associated with the correction factor CF₁ (1=1 to m) (m is an integer from 1 to n, both inclusive) and the blend shape model BSMᵢ (i=1 to n). The face generation unit 13 generates the face FM of the character on the basis of the following equation (2) using the transformation Pᵢ^{c} (i=1 to n) thus corrected, the blend shape parameter αᵢ (i=1 to n), and the correction parameter βⱼ (j=1 to k). The face generation unit 13 outputs data of a matrix X of the face FM thus generated to the display control unit 14.

$$\begin{matrix}[ Equation 2 ] & \\ X = {X}_{0} + {\sum }_{i = 1}^{m} {α}_{i} {P}_{i} {\sum }_{j = 1}^{k} {β}_{j} {M}_{i j} + {\sum }_{i = 1}^{n - m} {α}_{i} {P}_{i} = {\sum }_{i = 1}^{m} {α}_{i} {P}_{i}^{c} + {\sum }_{i = 1}^{n - m} {α}_{i} {P}_{i} & ( 2 )\end{matrix}$$

In the equation (2), the expression of the character is generated from a combination of the n blend shape models BSM and the k correction factors CF. n denoting the number of blend shape model BSMs and k denoting the number of correction factors CF may be equal to or greater than 1, preferably equal to or greater than 2. In this case, the plurality of blend shape models BSM and the plurality of correction factors CF are combined to generate a realistic expression reflecting subtle movement in the mind of the character.

The display control unit 14 causes the display device 81 to display various types of information necessary for information processing according to the present embodiment. For example, the display control unit 14 causes the display device 81 to display various types of information on the model data 42 and the correction data 43. The display control unit 14 causes the display device 81 to display the face FM of the character generated by the face generation unit 13. The face FM of the character is formed of a polygon mesh defined by the matrix X.

The mesh deformation detection unit 15 detects an amount of deformation ΔQ of the polygon mesh when the user deforms the face FM by individually shifting a specific vertex F_{V}, side F_{S}, or plane F_{P} of the polygon mesh of which the face FM is formed. For example, the mesh deformation detection unit 15 detects a difference (X′−X) between the matrix X representing the face FM before deformation and a matrix X′ representing the face FM after deformation as ΔQ. When defining a new correction factor CF that is not stored in the storage unit 40, the user can directly deform the polygon mesh of the face FM generated by the face generation unit 13 and associate a change in the expression due to the deformation with the newly defined correction factor CF. The user can also adjust the change in the expression associated with the correction factor CF by directly deforming the polygon mesh.

The correction equation generation unit 16 acquires, from the mesh deformation detection unit 15, the amount of deformation ΔQ applied by the user to the face FM generated on the basis of one blend shape model BSM. The correction equation generation unit 16 generates a correction equation M_{g} for correcting the transformation P between the base model BM and the one blend shape model BSM on the basis of the amount of deformation ΔQ.

For example, in order to adjust an expression corrected by one correction factor CF through deformation of the polygon mesh and associate the expression thus adjusted with a default correction factor CF, the correction equation generation unit 16 generates the correction equation M_{g} on the basis of the following equation (3). M in the equation (3) denotes a correction equation stored in the storage unit 40 with the correction equation associated with the one blend shape model BSM and the one correction factor CF.

[Equation 3]

M_{g}=P⁻¹ΔQ (3)

The correction equation generation unit 16 outputs the correction equation M_{g} thus generated to the storage unit 40. The storage unit 40 stores the correction equation M_{g} acquired from the correction equation generation unit 16 with the correction equation M_{g} associated with the one blend shape model BSM and correction factor CF described above instead of the correction equation M of the equation (3) stored in the storage unit 40.

For example, in order to adjust an expression not corrected by a correction factor CF through deformation of the polygon mesh and associate the expression thus adjusted with a newly defined correction factor CF, the correction equation generation unit 16 generates the correction equation M_{g} on the basis of the following equation (3).

The correction equation generation unit 16 outputs the correction equation M_{g} thus generated to the storage unit 40. The storage unit 40 stores the correction equation M_{g} acquired from the correction equation generation unit 16 with the correction equation M_{g} associated with the one blend shape model BSM and the newly defined correction factor CF described above.

[2-2. User Interface]

Hereinafter, an example of a user interface UI1 used for the information processing according to the present embodiment will be described. The user performs the information processing according to the present embodiment via a user interface IF including the display control unit 14.

[2-2-1. User Interface for Face Generation Processing]

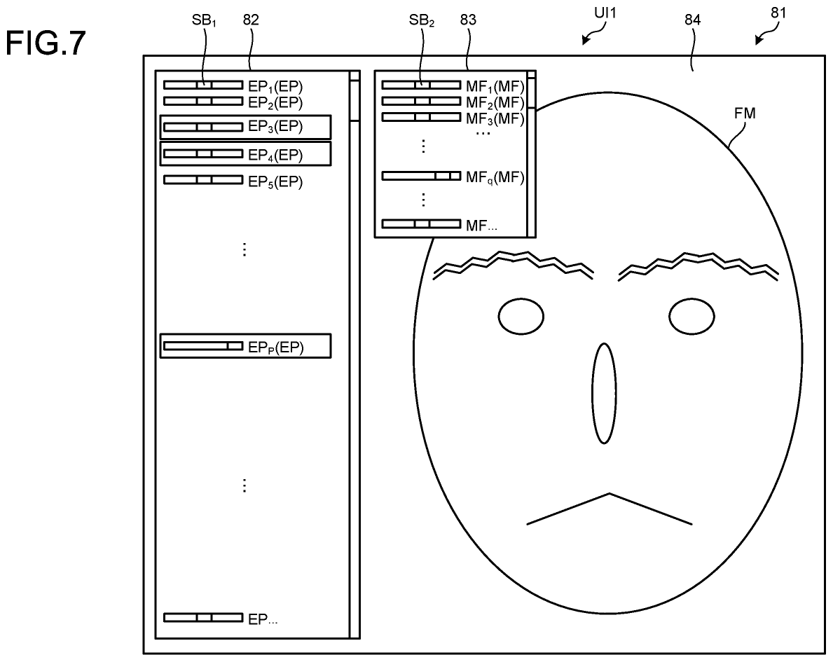

FIG. 7 is a diagram illustrating an example of how to perform the face generation processing via the user interface UI1.

The display control unit 14 causes the display device 81 to display a blend shape parameter input field 82, a correction parameter input field 83, and a preview area 84.

In the blend shape parameter input field 82, a list of a plurality of expression models EP and a plurality of slide bars SB1 each used for inputting the magnitude of a corresponding expression model EP are displayed, for example. When the user operates each slide bar SB1 to set the magnitude greater than 0, an expression model EP to be blended with the base model BM is selected. The expression model EP is displayed in the blend shape parameter input field 82 in the form of, for example, a character string, but the display format of the expression model EP is not limited to such a character string. The expression model EP may be displayed in the blend shape parameter input field 82 in the form of, for example, a picture of a deformed face.

At least one blend shape model BSM is blended with the base model BM with a predetermined weight to generate each expression model EP. The number of expression models EP displayed in the blend shape parameter input field 82 is larger than the number of blend shape models BSM stored in the storage unit 40, for example. This allows variations of expressions larger than the expressions defined by each blend shape model BSM to be presented to the user. The number of expression models EP displayed in the blend shape parameter input field 82 may be smaller than the number of blend shape models BSM stored in the storage unit 40. This reduces a burden on the user for checking or adjusting the large number of expression models EP.

The user slides each slide bar SB1 to adjust the magnitude of a corresponding expression model EP. The blend shape parameter acquisition unit 11 computes the weight of each blend shape model BSM to be blended with the base model BM on the basis of the magnitude of each expression model EP input by the user. The blend shape parameter acquisition unit 11 acquires the weight of each blend shape model BSM obtained by the computation as a blend shape parameter.

In the correction parameter input field 83, a list of a plurality of model factors MF and a plurality of slide bars SB2 each used for setting the magnitude of a corresponding model factor MF are displayed, for example. When the user operates a slide bar SB2 to set the magnitude of a corresponding model factor MF greater than 0, the model factor MF used for correcting the expression of the character is selected. The model factor MF is displayed in the correction parameter input field 83 in the form of, for example, a character string, but the display format of the model factor MF is not limited to such a character string. The model factor MF may be displayed in the correction parameter input field 83 in the form of, for example, a picture of a deformed face.

Each model factor MF is generated from a combination of at least one correction factor CF. The number of model factors MF displayed in the correction parameter input field 83 is larger than the number of correction factors CF stored in the storage unit 40, for example. This allows variations of correction factors larger than the factors defined by each correction factor CF to be presented to the user. The number of model factors MF displayed in the correction parameter input field 83 may be smaller the number of correction factors CF stored in the storage unit 40. This reduces a burden on the user for checking or adjusting the large number of model factors MF.

The user slides a slide bar SB2 to adjust the magnitude of a corresponding model factor MF. The correction parameter acquisition unit 12 computes the magnitude of each correction factor CF on the basis of the magnitude of each model factor MF input by the user. The correction parameter acquisition unit 12 acquires the magnitude of each correction factor CF obtained by the computation as a correction parameter.

In the initial state, for example, the magnitude of each expression model EP and the magnitude of each model factor MF are both set to 0. In the preview area 84, the face FM corresponding to the base model BM is displayed. When the user operates the slide bar SB1 and the slide bar SB2 to select a specific expression model EP and model factor MF, the face FM corresponding to the amount of operation of the slide bar SB1 and the slide bar SB2 is displayed in the preview area 84. When the user further operates the slide bar SB1 and the slide bar SB2, the face FM displayed in the preview area 84 is changed in proportion to the amount of operation.

When at least one model factor MF is selected by the user, the display control unit 14 highlights, among the plurality of expression models EP displayed in the blend shape parameter input field 82, at least one expression model EP whose expression is affected by the at least one model factor MF selected in the correction parameter input field 83.

For example, in the example illustrated in FIG. 7, the magnitude of the model factor “MF_{q}” is set greater than 0. As examples of the expression model EP whose expression is affected by the model factor “MF_{q}”, three expression models “EP₃”, “EP₄”, and “EP_{P}” are given. The display control unit 14 highlights character strings indicating the expression models “EP₃”, “EP₄”, and “EP_{P}” and the slide bars SB1 corresponding to the expression models “EP₃”, “EP₄”, and “EP_{P}” in the blend shape parameter input field 82.

In the preview area 84, the face FM of the character is displayed, the face FM being generated by the face generation unit 13 on the basis of the at least one expression model EP selected in the blend shape parameter input field 82 and the magnitude of the expression model EP, and the at least one model factor MF selected in the correction parameter input field 83 and the magnitude of the model factor MF. When the user changes the expression model EP or the magnitude of the expression model EP, or the model factor MF or the magnitude of the model factor MF, the face generation unit 13 generates a new face FM in response to the change. The display control unit 14 displays the face FM thus newly generated in the preview area 84.

In the blend shape parameter input field 82, the at least one expression model EP whose expression is affected by the at least one model factor MF selected in the correction parameter input field 83 is highlighted so as to be distinguishable from the other expression models EP. The user can select the at least one expression model EP thus highlighted one after another and efficiently check the expression of the at least one expression model EP associated with a common model factor MF.

[2-2-2. Face Generation Processing Flow]

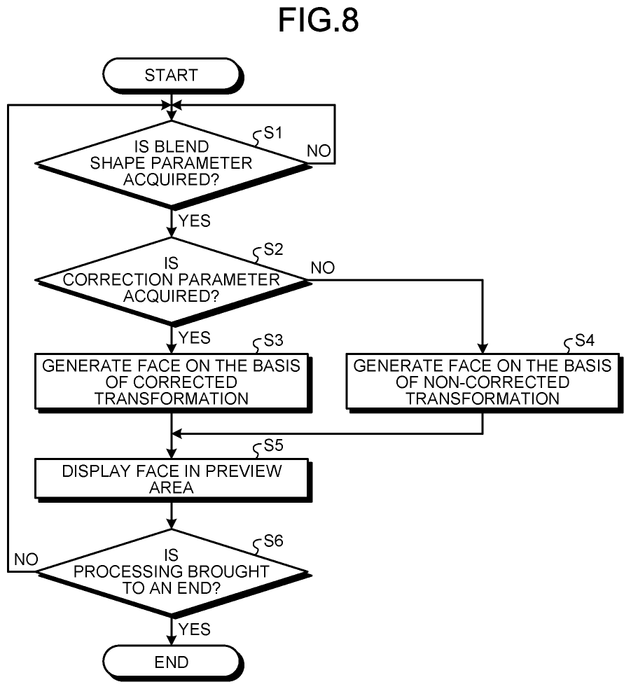

FIG. 8 is a flowchart illustrating an information processing method applied to the face generation processing. The face generation processing is performed via the user interface UI1 illustrated in FIG. 7, for example.

In step S1, the blend shape parameter acquisition unit 11 determines whether the blend shape parameter α has been acquired.

When a weight greater than 0 is input for at least one blend shape model BSM, the blend shape parameter acquisition unit 11 determines that a blend shape parameter has been acquired. When the weights of all the blend shape models BSM are 0, the blend shape parameter acquisition unit 11 determines that no blend shape parameter has been acquired. The weight of each blend shape parameter BSM is computed on the basis of at least one expression model EP selected in the blend shape parameter input field 82 and the magnitude of the expression model EP. When the number of blend shape models BSM for which a weight greater than 0 is input is n (n is an integer from 1 to N, both inclusive), the blend shape parameter acquisition unit 11 acquires n blend shape parameters αᵢ (i=1 to n) each indicating the weight of a corresponding one of the n blend shape models BSMᵢ (i=1 to n).

When a result of the determination in step S1 shows that the blend shape parameter acquisition unit 11 determines that a blend shape parameter has been acquired (step S1: Yes), the processing proceeds to step S2. When the result of the determination shows that the blend shape parameter acquisition unit 11 determines that no blend shape parameter has been acquired (step S1: No), the determination in step S1 is repeated until the blend shape parameter acquisition unit 11 acquires a blend shape parameter.

In step S2, the correction parameter acquisition unit 12 determines whether the correction parameter β has been acquired. When a value greater than 0 is input for at least one correction factor CF, the correction parameter acquisition unit 12 determines that a correction parameter has been acquired. When a value equal to 0 is input for all the correction factors CF, the correction parameter acquisition unit 12 determines that no correction parameter has been acquired. The magnitude of each correction factor CF is computed on the basis of at least one model factor MF selected in the correction parameter input field and the magnitude of the model factor MF. When the number of correction factors CF for which a value greater than 0 is input is k (k is an integer equal to or greater than 1), the correction parameter acquisition unit 12 acquires k correction parameters βⱼ (j=1 to k) each indicating the magnitude of a corresponding one of the k correction factors CF.

When a result of the determination in step S2 shows that the correction parameter acquisition unit 12 determines that a correction parameter has been acquired (step S2: Yes), the processing proceeds to step S3.

In step S3, the face generation unit 13 corrects the transformation Pᵢ (i=1 to n) between the base model BM and the blend shape model BSMᵢ (i=1 to n) on the basis of the correction equation Mᵢⱼ associated with the correction factor CF₁ (1=1 to m) and the blend shape model BSMᵢ (i=1 to n). The face generation unit 13 generates the face FM of the character on the basis of the equation (2) using the transformation Pᵢ^{c} (i=1 to n) thus corrected, the blend shape parameter αᵢ (i=1 to n), and the correction parameter βⱼ (j=1 to k). The face generation unit 13 outputs data of a matrix X of the face FM thus generated to the display control unit 14.

Next, in step S5, the display control unit 14 displays the face FM of the character in the preview area 84 on the basis of the data of the matrix X.

Next, in step S6, the display control unit 14 determines whether to bring the processing to an end. When an instruction to bring the processing to an end is received from the user by operation of an end button or the like, the display control unit 14 determines to bring the processing to an end (step S6: Yes) and brings the processing illustrated in FIG. 8 to an end. When it is determined to continue the processing (step S6: No), the processing returns to step S1.

When the result of the determination in step S2 shows that the correction parameter acquisition unit 12 determines that no correction parameter has been acquired (step S2: No), the processing proceeds to step S4.

In step S4, the face generation unit 13 generates the face FM of the character on the basis of the equation (1) using the transformation Pᵢ (i=1 to n) between the base model BM and the blend shape model BSMᵢ (i=1 to n) and the blend shape parameter αᵢ (i=1 to n). The face generation unit 13 outputs data of a matrix X of the face FM thus generated to the display control unit 14. Then, the processing proceeds to step S5.

[2-2-3. User Interface for Correction Equation Generation Processing]

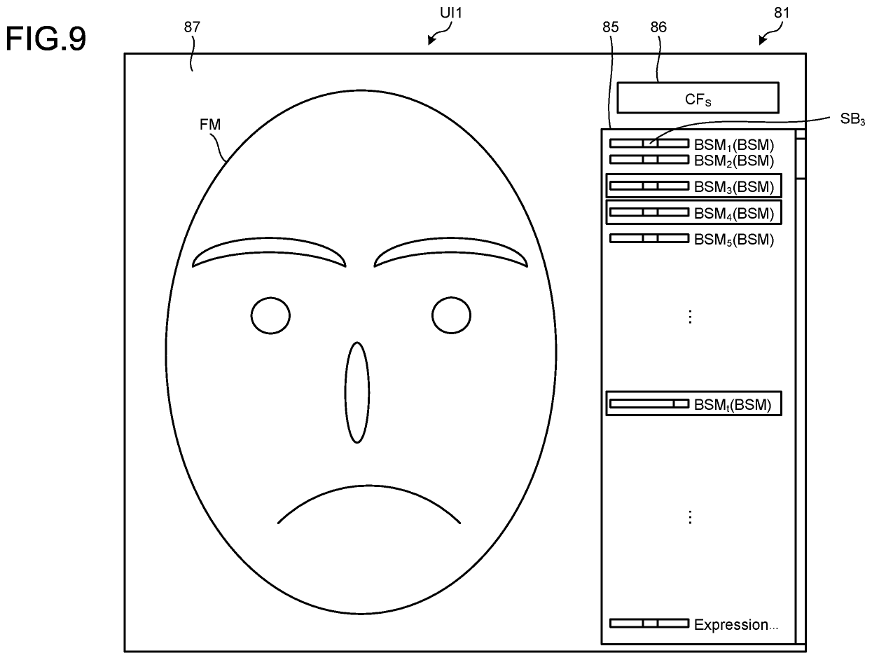

FIG. 9 is a diagram illustrating an example of how to perform a correction equation generation processing via the user interface UI1.

The display control unit 14 causes the display device 81 to display a blend shape model selection field 85, a correction factor input field 86, and an edit area 87.

In the blend shape model selection field 85, for example, a list of a plurality of blend shape models BSM and a plurality of slide bars SB3 for enabling or disabling selection of each blend shape model BSM are displayed. When the user slides the slide bar SB3 to enable selection, a blend shape model BSM to be blended with the base model BM is selected. The blend shape model BSM is displayed in the blend shape model selection field 85 in the form of, for example, a character string, but the display format of the blend shape model BSM is not limited to such a character string. The blend shape model BSM may be displayed in the blend shape model selection field 85 in the form of, for example, a picture of a deformed face.

One blend shape model BSM thus selected is blended with the base model BM with a weight of 100%. The blend shape parameter acquisition unit 11 acquires the weight of the blend shape model BSM selected by the user as the blend shape parameter α.

A correction factor CF is input to the correction factor input field 86. For example, in order to adjust an expression corrected by the correction factor CF through deformation of the polygon mesh and associate the expression thus adjusted with the correction factor CF, the correction factor CF to be adjusted is input to the correction factor input field 86. The magnitude of the correction factor CF (correction parameter β) thus selected is 1. The correction parameter acquisition unit 12 acquires the magnitude of a default correction factor CF selected by the user as the correction parameter β.

In order to adjust an expression not corrected by a correction factor CF through deformation of the polygon mesh and associate the expression thus adjusted with a newly defined correction factor CF, the newly defined correction factor CF is input to the correction factor input field 86. When the newly defined correction factor CF is input to the correction factor input field 86, the correction parameter acquisition unit 12 acquires no correction parameter β.

When the default correction factor CF stored in the storage unit 40 is input to the correction factor input field 86, the display control unit 14 highlights, among the plurality of blend shape models BSM displayed in the blend shape model selection field 85, at least one blend shape model BSM whose expression is affected by the correction factor CF input to the correction factor input field 86.

For example, in the example illustrated FIG. 9, “CFₛ” is input as a default correction factor CF in the correction factor input field 86. As examples of the blend shape model BSM whose expression is affected by the correction factor “CFₛ”, three blend shape models “BSM₃”, “BSM₄”, and “BSMₜ” are given. The display control unit 14 highlights the character strings indicating the blend shape models “BSM₃”, “BSM₄”, and “BSMₜ” and the slide bars SB3 corresponding to the blend shape models “BSM₃”, “BSM₄”, and “BSMₜ” in the blend shape model selection field 85.

In the edit area 87, the face FM to be edited is displayed. For example, in order to adjust an expression corrected by a correction factor CF through deformation of the polygon mesh and associate the expression thus adjusted with the correction factor CF, the face FM of the character is displayed in the edit area 87, the face FM being generated by the face generation unit 13 on the basis of the blend shape model BSM selected in the blend shape model selection field 85 and the correction factor CF input to the correction factor input field 86. In order to adjust an expression not corrected by a correction factor CF through deformation of the polygon mesh and associate the expression thus adjusted with the newly defined correction factor CF, the face FM of the character is displayed in the edit area 87, the face FM being generated by the face generation unit 13 on the basis of the blend shape model BSM selected in the blend shape model selection field 85.

In the edit area 87, the user can deform the face by individually shifting a specific vertex F_{V}, side F_{S}, or plane F_{P} of the polygon mesh of which the face FM is formed. The amount of deformation ΔQ applied to the face FM by the user via the edit area 87 is detected by the mesh deformation detection unit 15. The correction equation generation unit 16 generates the correction equation M_{g} on the basis of the equation (3) using the amount of deformation ΔQ. The storage unit 40 stores the correction equation M_{g} thus generated with the correction equation M_{g} associated with the blend shape model BSM selected in the blend shape model selection field 85 and the correction factor CF input to the correction factor input field 86.

When the user changes the blend shape model BSM or the correction factor CF, the face generation unit 13 generates a new face FM in response to the change. The display control unit 14 displays the face FM thus newly generated in the edit area 87. When a default correction factor CF stored in the storage unit 40 is input to the correction factor input field 86, at least one blend shape model BSM whose expression is affected by the default correction factor CF input to the correction factor input field 86 is highlighted in the blend shape model selection field 85 so as to be distinguishable from the other blend shape models BSM. The user can select the at least one blend shape model BSM thus highlighted one after another and efficiently adjust the expression of the at least one blend shape model BSM associated with a common correction factor CF.

[2-2-4. Correction Equation Generation Processing Flow]

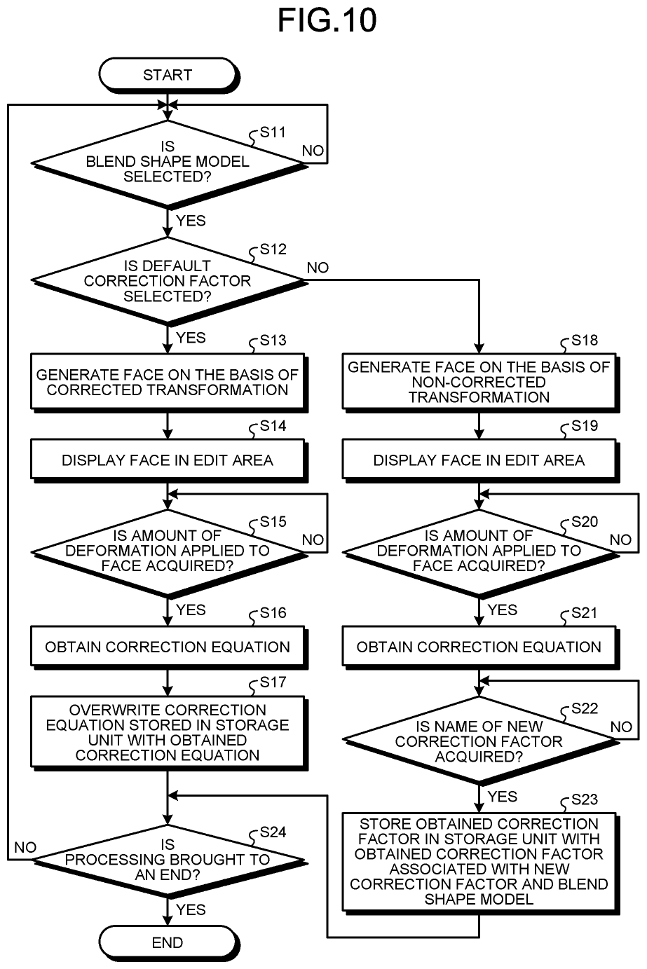

FIG. 10 is a flowchart illustrating an information processing method applied to the correction equation generation processing. The correction equation generation processing is performed via the user interface UI1 illustrated in FIG. 9, for example.

In step S11, the blend shape parameter acquisition unit 11 determines whether a blend shape model BSM to be blended with the base model BM has been selected. When the user selects one blend shape model BSM via the slide bar SB2, the blend shape parameter acquisition unit 11 sets the weight of the one blend shape model BSM to 100% and acquires the weight as the blend shape parameter α. Upon acquisition of the blend shape parameters α, the blend shape parameter acquisition unit 11 determines that the blend shape model BSM has been selected. When the user does not operate any of the slide bars SB2, and no blend shape parameter α is acquired accordingly, the blend shape parameter acquisition unit 11 determines that no blend shape model BSM has been selected.

When a result of the determination in step S11 shows that the blend shape parameter acquisition unit 11 determines that the blend shape model BSM has been selected (step S11: Yes), the processing proceeds to step S12. When the result of the determination in step S11 shows that the blend shape parameter acquisition unit 11 determines that no blend shape model BSM has been selected (step S11: No), the determination in step S11 is repeated until a blend shape model BSM is selected.

In step S12, the correction parameter acquisition unit 12 determines whether the user has input a default correction factor CF stored in the storage unit 40 to the correction factor input field 86. When a correction factor CF input to the correction factor input field 86 is identical to any correction factor CF stored in the storage unit 40, the correction parameter acquisition unit 12 determines that a default correction factor CF has been input. In this case, the correction parameter acquisition unit 12 acquires 1 as the correction parameter β for the correction factor CF thus input. When no correction factor CF is input to the correction factor input field 86 illustrated in FIG. 9 or when an input correction factor CF is not identical to any correction factor CF stored in the storage unit 40, the correction parameter acquisition unit 12 determines that no default correction factor CF has been input.

When a result of the determination in step S12 shows that the correction parameter acquisition unit 12 determines that a default correction factor CF has been input to the correction factor input field 86 (step S12: Yes), the processing proceeds to step S13.

In step S13, the face generation unit 13 corrects the transformation P between the blend shape model BSM selected in step S11 and the base model BM on the basis of the correction factor CF input in step S12 and the correction equation M associated with the blend shape model BSM selected in step S11. The face generation unit 13 generates the face FM of the character on the basis of the equation (2) using the transformation P^{c} thus corrected, the blend shape parameter α, and the correction parameter β. The face generation unit 13 outputs data of a matrix X of the face FM thus generated to the display control unit 14.

Next, in step S14, the display control unit 14 displays the face FM of the character in the edit area 87 on the basis of the data of the matrix X.

Next, in step S15, the mesh deformation detection unit 15 determines whether the amount of deformation ΔQ applied to the face FM by the user via the edit area 87 has been acquired. For example, the mesh deformation detection unit 15 detects a difference (X′−X) between the matrix X representing the face FM before deformation and a matrix X′ representing the face FM after deformation as ΔQ. When ΔQ is not equal to 0, the mesh deformation detection unit 15 determines that the amount of deformation ΔQ has been acquired. When ΔQ is equal to 0, the mesh deformation detection unit 15 determines that no amount of deformation ΔQ has been acquired.

When a result of the determination in step S15 shows that the mesh deformation detection unit 15 determines that the amount of deformation ΔQ has been acquired (step S15: Yes), the processing proceeds to step S16. When the result of the determination in step S15 shows that the mesh deformation detection unit 15 determines that no amount of deformation ΔQ has been acquired (step S15: No), the determination in step S15 is repeated until the mesh deformation detection unit 15 acquires the amount of deformation ΔQ.

In step S16, the correction equation generation unit 16 generates the correction equation M_{g} on the basis of the equation (3) using the amount of deformation ΔQ.

Next, in step S17, the storage unit 40 stores the correction equation M_{g} generated in step S16 with the correction equation M_{g} associated with the blend shape model BSM selected in the blend shape model selection field 85 and the correction factor CF input to the correction factor input field 86.

Next, in step S24, the display control unit 14 determines whether to bring the processing to an end. When an instruction to bring the processing to an end is received from the user by operation of an end button or the like, the display control unit 14 determines to bring the processing to an end (step S24: Yes) and brings the processing illustrated in FIG. 10 to an end. When it is determined to continue the processing (step S24: No), the processing returns to step S11.

When the result of the determination in step S12 shows that the correction parameter acquisition unit 12 determines that no default correction factor CF has been input to the correction factor input field 86 (step S12: No), the processing proceeds to step S18.

In step S18, the face generation unit 13 generates the face FM of the character on the basis of the equation (1) using the transformation P between the blend shape model BSM selected in step S11 and the base model BM, and the blend shape parameter α. The face generation unit 13 outputs data of a matrix X of the face FM thus generated to the display control unit 14.

Next, in step S19, the display control unit 14 displays the face FM of the character in the edit area 87 on the basis of the data of the matrix X.

Next, in step S20, the mesh deformation detection unit 15 determines whether the amount of deformation ΔQ applied to the face FM by the user via the edit area 87 has been acquired.

When a result of the determination in step S20 shows that the mesh deformation detection unit 15 determines that the amount of deformation ΔQ has been acquired (step S20: Yes), the processing proceeds to step S21. When the result of the determination in step S20 shows that the mesh deformation detection unit 15 determines that no amount of deformation ΔQ has been acquired (step S20: No), the determination in step S20 is repeated until the mesh deformation detection unit 15 acquires the amount of deformation ΔQ.

In step S21, the correction equation generation unit 16 generates the correction equation M_{g} on the basis of the equation (3) using the amount of deformation ΔQ.

Next, in step S22, the correction parameter acquisition unit 12 determines whether the user has input a new correction factor CF that is not stored in the storage unit 40 to the correction factor input field 86.

When a result of the determination in step S22 shows that the correction parameter acquisition unit 12 determines that a new correction factor CF has been input to the correction factor input field 86 (step S22: Yes), the processing proceeds to step S23. When the result of the determination in step S22 shows that the correction parameter acquisition unit 12 determines that no new correction factor CF has been input to the correction factor input field 86 (step S22: No), the determination in step S22 is repeated until a new correction factor CF is input to the correction factor input field 86.

In step S23, the storage unit 40 stores the correction equation M_{g} generated in step S21 with the correction equation M_{g} associated with the blend shape model BSM input to the blend shape model selection field 85 and the correction factor CF input to the correction factor input field 86. Then, the processing proceeds to step S24.

### 3. Second Embodiment

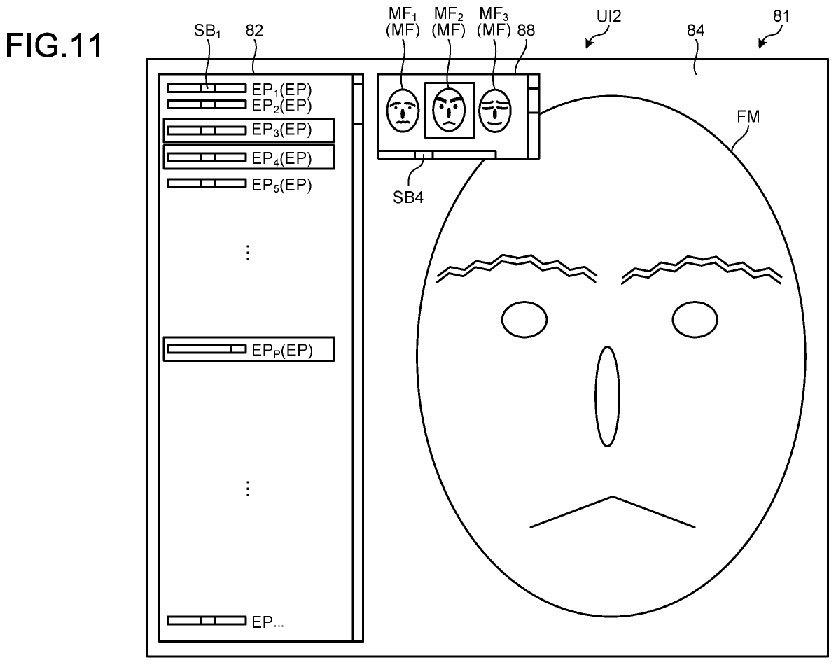

FIG. 11 is a diagram illustrating an example of a user interface UI2 according to the second embodiment.

The present embodiment is different from the first embodiment in that each model factor MF is displayed in a correction parameter input field 88 in the form of a picture of a deformed face. Representing the model factor MF in the form of a picture allows intuitive understanding of how the model factor MF affects the expression of the character.

In the correction parameter input field 88, a plurality of model factors MF is listed in the form of pictures of deformed faces. The user can select each model factor MF one by one by mouse clicking or the like. In the example illustrated in FIG. 11, the model factor MF₂ is selected by the user. A picture of the model factor MF₂ thus selected is inverted and displayed in the correction parameter input field 88 so as to be distinguishable from the other model factors MF, for example. One slide bar SB4 used for setting the magnitude of the selected model factor MF is displayed on a lower side of the correction parameter input field 88.

### 4. Modification of Correction Factor

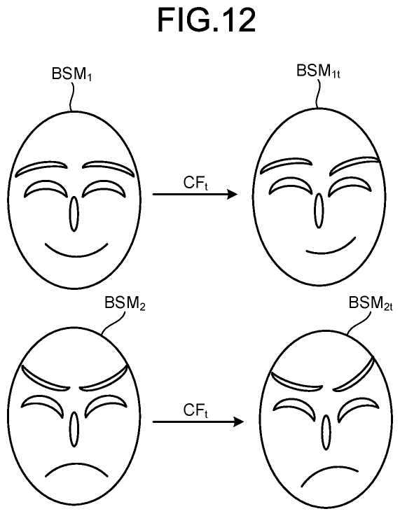

FIG. 12 is a diagram illustrating a modification of a correction factor.

In the first embodiment, the mood of the character has been given as an example of the correction factor CF. The correction factor CF, however, is not necessarily limited to such a mood and may be any factor that affects the expression of the character.

In the example illustrated in FIG. 12, an expression tendency unique to the character (habit appearing in expressing a feeling) is given as the correction factor CF. Some people move their eyebrows or corners of their mouths in an asymmetric manner when expressing their feelings. A habit appearing in expression such as either the left or right corner of the mouth being easily raised when smiling tends to clearly show the personality of the character. Such a habit is therefore useful in characterizing the character.

For example, when a tendency of the left eyebrow and the left corner of the mouth being easily raised is defined as a correction factor CFₜ, as illustrated in the upper part of FIG. 12, the blend shape model BSM₁ representing a smiling face is corrected to a face where the left eyebrow and the left corner of the mouth turn upward as compared with the right eyebrow and the right corner of the mouth (correction model BSM₁ₜ) Such an expression tendency widely affects other expressions. Therefore, as illustrated in the lower part of FIG. 12, the blend shape model BSM₂ representing an angry face (correction model BSM₂ₜ) can be corrected in the same manner.

### 5. Effects

The information processing system 1 according to the present embodiment includes the blend shape parameter acquisition unit 11, the correction parameter acquisition unit 12, and the face generation unit 13. The blend shape parameter acquisition unit 11 acquires the weight of the blend shape model BSM to be blended with the base model BM as the blend shape parameter α. The correction parameter acquisition unit 12 acquires the magnitude of the correction factor CF that affects the expression of the blend shape model BSM as the correction parameter β. The face generation unit 13 corrects the transformation P between the base model BM and the blend shape model BSM on the basis of the correction equation M associated with the correction factor CF and the blend shape model BSM, and generates the face of the character using the transformation P^{c} thus corrected, the blend shape parameter α, and the correction parameter β. The information processing method according to the present embodiment causes a computer to perform the above-described information processing of the information processing system 1. Further, the program 41 according to the present embodiment causes the computer to perform the above-described information processing of the information processing system 1.

According to this configuration, a new concept of the correction factor CF is introduced as a factor that affects various abstract expressions such as a mood. Introducing a new parameter, i.e. the correction factor CF, into the blend shape allows the face generation processing to be performed with comprehensive consideration given to not only simple feeling expressions such as joy, anger, grief, and pleasure, but also various factors that affect the expression of the character such as a state of mind and body and a wavering mind. Further, a degree of influence of the correction factor CF on the expression is defined as the correction parameter. Combining various correction factors CF with consideration given to such a degree of influence allows a more subtle change in expression to be obtained.

The correction factor CF itself is a parameter having a clear meaning such as a mood. This allows the user to easily predict how the face of the character changes with reference to the correction factor CF. This in turn eases confusion as to which correction factor CF is to be combined in what magnitude in accordance with a change in the feeling of the character or the like. For example, a method for controlling a FACS-compliant parameter or an expression parameter (a parameter higher in abstraction level than FACS such as a smiling face or a sad face) in the related art requires the user to estimate a parameter indirectly related to a change in mood on the basis of experience or intuition of the user because there is no parameter directly representing the mood. It is further required that the user find a suitable combination of magnitudes of parameters corresponding to the magnitude of the mood by trial and error. This method requires the user to repeat trial and error every time the mood changes, which puts a large burden on the user. On the other hand, according to the present embodiment, a suitable expression can be obtained by selecting the correction equation associated with the mood. Even when the magnitude of the mood changes, a subtle change in expression is realized only by changing the magnitude of the correction parameter. This reduces the burden on the user.

Further, in a scene where the same correction factor CF continuously affects the expression of the character, various expressions that can be taken by the character can be collectively corrected using the same correction factor CF and the same correction parameter β. For example, when the user wants to change the mood of the character and re-create an animation, the user can re-create the animation only by adjusting a parameter that affects the whole or part of the animation without changing each blend shape parameter for each frame or each keyframe. This significantly reduces the burden on the user.

The correction factor CF is, for example, a mood of the character or an expression tendency unique to the character.

According to this configuration, it is possible to perform the face generation processing with comprehensive consideration given to various factors that affect the expression of the character such as a state of mind and body, a wavering mind, or a habit appearing in expressing a feeling. Further, a habit appearing in expression such as either the left or right corner of the mouth being easily raised when smiling tends to clearly show the personality of the character. Such a habit is therefore useful in characterizing the character.

The blend shape model BSM is, for example, an expression model representing an emotion.

The expression is a change appearing on a face in response to an emotion. The emotion is different from either a mood or an expression tendency (habit). The emotion is a strong feeling caused by a clear factor, accompanied by physiological excitement such as fear, anger, or joy and typically lasts for a short period of time. A feeling weaker than the emotion is referred to as a mood. The mood is not necessarily a conscious feeling, and may be caused by an unclear factor. As for the mood, there is no significant change in feeling, but the mood last longer than the emotion. According to the blend shape in the related art, the expression of the character is generated only from the expression model based on the emotion. This makes it difficult to obtain a subtle change in expression with consideration given to the mood. On the other hand, according to the present embodiment, a new concept such as the mood different from the emotion is introduced as the correction factor CF. This allows a more complicated and realistic expression to be obtained.

The blend shape parameter acquisition unit 11 acquires, for example, n blend shape parameters α each indicating the weight of a corresponding one of n (n is an integer equal to or greater than 1) blend shape models BSM to be blended with the base model BM. The correction parameter acquisition unit 12 acquires, for example, k correction parameters β each indicating the magnitude of a corresponding one of k (k is an integer equal to or greater than 1) correction factors CF that affect the expression of the character. The face generation unit 13 corrects, for example, m (m is an integer from 1 to n, both inclusive) transformations P affected by the k correction factors CF among n transformations P each used for transformation between the base model BM and a corresponding one of the n blend shape models BSM, and generates the face of the character using the n transformations including the m transformations P^{c} thus corrected.

According to this configuration, the plurality of blend shape models BSM and the plurality of correction factors CF are combined to generate a realistic expression reflecting subtle movement in the mind of the character.

The information processing system 1 according to the present embodiment includes the mesh deformation detection unit 15 and the correction equation generation unit 16. The mesh deformation detection unit 15 detects an amount of deformation ΔQ of the polygon mesh when the user deforms the face FM by individually shifting a specific vertex F_{V}, side F_{S}, or plane F_{P} of the polygon mesh of which the face FM is formed. The correction equation generation unit 16 acquires, from the mesh deformation detection unit 15, the amount of deformation ΔQ applied to the face FM by the user, the face FM being generated on the basis of one blend shape model BSM, and generates the correction equation M used for correcting the transformation P between the base model BM and the one blend shape model BSM on the basis of the amount of deformation ΔQ.

According to this configuration, it is possible to finely adjust a change in expression caused by the correction factor CF.

The information processing system 1 includes the storage unit 40. The storage unit 40 stores a plurality of transformations P used for transformation between the base model BM and a plurality of blend shape models BSM, and a plurality of correction factors CF. The storage unit 40 stores, for each correction factor CF, at least one blend shape model BSM whose expression is affected by the correction factor CF and at least one correction equation M used for correcting at least one transformation P corresponding to the at least one blend shape model BSM with the at least one blend shape model BSM and the at least one correction equation M associated with each other.

According to this configuration, it is possible to generate various expressions using various correction factors CF.

The information processing system 1 includes the display control unit 14. The display control unit 14 causes the display device 81 to display the blend shape parameter input field 82, the correction parameter input field 83, and the preview area 84. In the blend shape parameter input field 82, a list of a plurality of expression models EP is displayed. In the correction parameter input field 83, a list of a plurality of model factors MF is displayed. In the preview area 84, the face FM of the character is displayed, the face FM being generated by the face generation unit 13 on the basis of at least one expression model EP selected in the blend shape parameter input field 82 and at least one model factor MF selected in the correction parameter input field 83. The display control unit 14 highlights, among the plurality of expression models EP displayed in the blend shape parameter input field 82, at least one expression model EP whose expression is affected by the at least one model factor MF selected in the correction parameter input field 83.

According to this configuration, the user can select the at least one expression model EP thus highlighted one after another and efficiently check the expression of the at least one expression model EP associated with a common model factor MF.

The display control unit causes the display device 81 to display the blend shape model selection field 85, the correction factor input field 86, and the edit area 87. In the blend shape model selection field 85, a list of a plurality of blend shape models BSM is displayed. A correction factor CF is input to the correction factor input field 86. In the edit area 87, the face FM of the character is displayed, the face FM being generated by the face generation unit 13 on the basis of one blend shape model BSM selected in the blend shape model selection field 85 and the correction factor CF input to the correction factor input field 86. In the edit area 87, the user can deform the face FM by individually shifting a specific vertex F_{V}, side F_{S}, or plane F_{P} of the polygon mesh of which the face FM is formed. The display control unit 14 highlights, among the plurality of blend shape models BSM displayed in the blend shape model selection field 85, at least one blend shape model BSM whose expression is affected by the correction factor CF input to the correction factor input field 86.

According to this configuration, the user can select the at least one blend shape model BSM thus highlighted one after another and efficiently adjust the expression of the at least one blend shape model BSM associated with a common correction factor CF.

The user interface UI1 according to the present embodiment includes the blend shape parameter input field 82, the correction parameter input field 83, and the preview area 84. In the blend shape parameter input field 82, a list of a plurality of expression models EP is displayed. In the correction parameter input field 83, a list of a plurality of model factors MF is displayed. In the preview area 84, the face FM of the character is displayed, the face FM being generated on the basis of at least one expression model EP selected in the blend shape parameter input field 82 and at least one model factor MF selected in the correction parameter input field 83. Each of the plurality of model factors MF affects the expression of at least one expression model EP of the plurality of expression models EP. Among the plurality of expression models EP displayed in the blend shape parameter input field 82, at least one expression model EP whose expression is affected by the at least one model factor MF selected in the correction parameter input field 83 is highlighted.

According to this configuration, the user can select the at least one expression model EP thus highlighted one after another and efficiently check the expression of the at least one expression model EP associated with a common model factor MF.

The interface UI1 includes the blend shape model selection field 85, the correction factor input field 86, and the edit area 87. In the blend shape model selection field 85, a list of a plurality of blend shape models BSM is displayed. A correction factor CF is input to the correction factor input field 86. In the edit area 87, the face FM of the character is displayed, the face FM being generated on the basis of one blend shape model BSM selected in the blend shape model selection field 85 and the correction factor CF input to the correction factor input field 86. In the edit area 87, the user can deform the face FM by individually shifting a specific vertex F_{V}, side F_{S}, or plane F_{P} of the polygon mesh of which the face FM is formed. The correction factor CF affects the expression of at least one blend shape model BSM among the plurality of blend shape models BSM. Among the plurality of blend shape models BSM displayed in the blend shape model selection field 85, at least one blend shape model BSM whose expression is affected by the correction factor CF input to the correction factor input field 86 is highlighted.

According to this configuration, the user can select the at least one blend shape model BSM thus highlighted one after another and efficiently adjust the expression of the at least one blend shape model BSM associated with a common correction factor CF.

Note that the effects described herein are merely examples and are not restrictively construed, and other effects may be provided.

Note that the present technology may also have the following configuration.

(1)

An information processing system comprising: a blend shape parameter acquisition unit that acquires a weight of a blend shape model to be blended with a base model as a blend shape parameter;

a correction parameter acquisition unit that acquires a magnitude of a correction factor that affects an expression of the blend shape model as a correction parameter; and

a face generation unit that corrects a transformation between the base model and the blend shape model on the basis of a correction equation associated with the correction factor and the blend shape model and generates a face of a character using the transformation corrected, the blend shape parameter, and the correction parameter.

(2)

The information processing system according to (1), wherein the correction factor is a mood of the character or an expression tendency unique to the character.

(3)

The information processing system according to (2), wherein the blend shape model is an expression model representing an emotion of the character.

(4)

The information processing system according to (1), wherein

the blend shape parameter acquisition unit acquires n blend shape parameters each indicating the weight of a corresponding one of n (n is an integer equal to or greater than 1) blend shape models to be blended with the base model,

the correction parameter acquisition unit acquires k correction parameters each indicating the magnitude of a corresponding one of k (k is an integer equal to or greater than 1) correction factors that affect the expression of the character, and

the face generation unit corrects, among n transformations each used for transformation between the base model and a corresponding one of the n blend shape models, m (m is an integer from 1 to n, both inclusive) transformation affected by the k correction factors and generates the face of the character using the n transformations including the m transformations corrected.

(5)

The information processing system according to any one of (1) to (4), further comprising:

a mesh deformation detection unit that detects an amount of deformation of a polygon mesh of which the face is formed when a user deforms the face by individually shifting a specific vertex, side, or plane of the polygon mesh; and

a correction equation generation unit that acquires, from the mesh deformation detection unit, the amount of deformation applied by the user to the face generated on the basis of one of the blend shape models, and generates a correction equation used for correcting a transformation between the base model and the one blend shape model on the basis of the amount of deformation.

(6)

The information processing system according to any one of (1) to (5), further comprising a storage unit that stores a plurality of transformations each used for transformation between the base model and a corresponding one of a plurality of the blend shape models, and a plurality of correction factors, wherein

the storage unit stores, for each correction factor, at least one blend shape model whose expression is affected by the correction factor and at least one correction equation used for correcting at least one transformation corresponding to the at least one blend shape model with at least one blend shape model and the at least one correction equation associated with each other.

(7)

The information processing system according to any one of (1) to (6), further comprising a display control unit that causes a display device to display a blend shape parameter input field where a list of a plurality of expression models is displayed, a correction parameter input field where a list of a plurality of model factors is displayed, and a preview area where a face of the character is displayed, the face being generated by the face generation unit on the basis of at least one expression model selected in the blend shape parameter input field and at least one model factor selected in the correction parameter input field, wherein

the display control unit highlights at least one expression model whose expression is affected by the at least one model factor selected in the correction parameter input field among the plurality of expression models displayed in the blend shape parameter input field.

(8)

The information processing system according to (7), wherein

the display control unit causes the display device to display a blend shape model selection field where a list of a plurality of blend shape models is displayed, a correction factor input field where a correction factor is input, and an edit area where a face of the character is displayed, the face being generated by the face generation unit on the basis of one blend shape model selected in the blend shape model selection field and the correction factor input to the correction factor input field and where a user is allowed to deform the face by individually shifting a specific vertex, side, or plane of a polygon mesh of which the face is formed, and

the display control unit highlights at least one blend shape model whose expression is affected by the correction factor input to the correction factor input field among the plurality of blend shape models displayed in the blend shape model selection field.

(9)

An information processing method executed by a computer, comprising:

acquiring a weight of a blend shape model to be blended with a base model as a blend shape parameter;

acquiring a magnitude of a correction factor that affects an expression of the blend shape model as a correction parameter; and

correcting a transformation between the base model and the blend shape model on the basis of a correction equation associated with the correction factor and the blend shape model and generating a face of a character using the transformation corrected, the blend shape parameter, and the correction parameter.

(10)

A program for causing a computer to execute a process, comprising:

acquiring a weight of a blend shape model to be blended with a base model as a blend shape parameter;

acquiring a magnitude of a correction factor that affects an expression of the blend shape model as a correction parameter; and

correcting a transformation between the base model and the blend shape model on the basis of a correction equation associated with the correction factor and the blend shape model and generating a face of a character using the transformation corrected, the blend shape parameter, and the correction parameter.

(11)

A user interface comprising:

a blend shape parameter input field where a list of a plurality of expression models is displayed;

a correction parameter input field where a list of a plurality of model factors is displayed; and

a preview area where a face of a character is displayed, the face being generated on the basis of at least one expression model selected in the blend shape parameter input field and at least one model factor selected in the correction parameter input field, wherein

each of the plurality of model factors affects an expression of at least one expression model among the plurality of expression models, and at least one expression model whose expression is affected by the at least one model factor selected in the correction parameter input field among the plurality of expression models displayed in the blend shape parameter input field is highlighted.

(12)

The user interface according to (11), further comprising: a blend shape model selection field where a list of a plurality of blend shape models is displayed;

a correction factor input field where a correction factor is input; and

an edit area where a face of the character is displayed, the face being generated on the basis of one blend shape model selected in the blend shape model selection field and the correction factor input to the correction factor input field and where a user is allowed to deform the face by individually shifting a specific vertex, side, or plane of a polygon mesh of which the face is formed, wherein

the correction factor affects an expression of at least one blend shape model among the plurality of blend shape models, and at least one blend shape model whose expression is affected by the correction factor input to the correction factor input field among the plurality of blend shape models displayed in the blend shape model selection field is highlighted.

### REFERENCE SIGNS LIST

1 INFORMATION PROCESSING SYSTEM
11 BLEND SHAPE PARAMETER ACQUISITION UNIT
12 CORRECTION PARAMETER ACQUISITION UNIT
13 FACE GENERATION UNIT
14 DISPLAY CONTROL UNIT
15 MESH DEFORMATION DETECTION UNIT
16 CORRECTION EQUATION GENERATION UNIT
40 STORAGE UNIT
81 DISPLAY DEVICE
82 BLEND SHAPE PARAMETER INPUT FIELD
83 CORRECTION PARAMETER INPUT FIELD
84 PREVIEW AREA
85 BLEND SHAPE MODEL SELECTION FIELD
86 CORRECTION FACTOR INPUT FIELD
87 EDIT AREA
88 CORRECTION PARAMETER INPUT FIELD
BM BASE MODEL
BSM, BSMᵢ, BSM₁, BSM₂, BSM_{N} BLEND SHAPE MODEL
CF, CFⱼ CORRECTION FACTOR
EP EXPRESSION MODEL
FM FACE
F_{V} VERTEX
F_{S} SIDE
F_{P} PLANE
M, Mᵢⱼ, M_{q} CORRECTION EQUATION
MF MODEL FACTOR
P, Pᵢ TRANSFORMATION
P^{c}, Pᵢ^{c} CORRECTED TRANSFORMATION
α, αᵢ BLEND SHAPE PARAMETER
β, βⱼ CORRECTION PARAMETER
ΔQ AMOUNT OF DEFORMATION

1. An information processing system comprising:
a blend shape parameter acquisition unit that acquires a weight of a blend shape model to be blended with a base model as a blend shape parameter;
a correction parameter acquisition unit that acquires a magnitude of a correction factor that affects an expression of the blend shape model as a correction parameter; and
a face generation unit that corrects a transformation between the base model and the blend shape model on the basis of a correction equation associated with the correction factor and the blend shape model and generates a face of a character using the transformation corrected, the blend shape parameter, and the correction parameter.

2. The information processing system according to claim 1, wherein
the correction factor is a mood of the character or an expression tendency unique to the character.

3. The information processing system according to claim 2, wherein
the blend shape model is an expression model representing an emotion of the character.

4. The information processing system according to claim 1, wherein
the blend shape parameter acquisition unit acquires n blend shape parameters each indicating the weight of a corresponding one of n (n is an integer equal to or greater than 1) blend shape models to be blended with the base model,
the correction parameter acquisition unit acquires k correction parameters each indicating the magnitude of a corresponding one of k (k is an integer equal to or greater than 1) correction factors that affect the expression of the character, and
the face generation unit corrects, among n transformations each used for transformation between the base model and a corresponding one of the n blend shape models, m (m is an integer from 1 to n, both inclusive) transformation affected by the k correction factors and generates the face of the character using the n transformations including the m transformations corrected.

5. The information processing system according to claim 1, further comprising:
a mesh deformation detection unit that detects an amount of deformation of a polygon mesh of which the face is formed when a user deforms the face by individually shifting a specific vertex, side, or plane of the polygon mesh; and
a correction equation generation unit that acquires, from the mesh deformation detection unit, the amount of deformation applied by the user to the face generated on the basis of one of the blend shape models, and generates a correction equation used for correcting a transformation between the base model and the one blend shape model on the basis of the amount of deformation.

6. The information processing system according to claim 1, further comprising a storage unit that stores a plurality of transformations each used for transformation between the base model and a corresponding one of a plurality of the blend shape models, and a plurality of correction factors, wherein
the storage unit stores, for each correction factor, at least one blend shape model whose expression is affected by the correction factor and at least one correction equation used for correcting at least one transformation corresponding to the at least one blend shape model with at least one blend shape model and the at least one correction equation associated with each other.

7. The information processing system according to claim 1, further comprising a display control unit that causes a display device to display a blend shape parameter input field where a list of a plurality of expression models is displayed, a correction parameter input field where a list of a plurality of model factors is displayed, and a preview area where a face of the character is displayed, the face being generated by the face generation unit on the basis of at least one expression model selected in the blend shape parameter input field and at least one model factor selected in the correction parameter input field, wherein
the display control unit highlights at least one expression model whose expression is affected by the at least one model factor selected in the correction parameter input field among the plurality of expression models displayed in the blend shape parameter input field.

8. The information processing system according to claim 7, wherein
the display control unit causes the display device to display a blend shape model selection field where a list of a plurality of blend shape models is displayed, a correction factor input field where a correction factor is input, and an edit area where a face of the character is displayed, the face being generated by the face generation unit on the basis of one blend shape model selected in the blend shape model selection field and the correction factor input to the correction factor input field and where a user is allowed to deform the face by individually shifting a specific vertex, side, or plane of a polygon mesh of which the face is formed, and
the display control unit highlights at least one blend shape model whose expression is affected by the correction factor input to the correction factor input field among the plurality of blend shape models displayed in the blend shape model selection field.

9. An information processing method executed by a computer, comprising:
acquiring a weight of a blend shape model to be blended with a base model as a blend shape parameter;
acquiring a magnitude of a correction factor that affects an expression of the blend shape model as a correction parameter; and
correcting a transformation between the base model and the blend shape model on the basis of a correction equation associated with the correction factor and the blend shape model and generating a face of a character using the transformation corrected, the blend shape parameter, and the correction parameter.

10. A program for causing a computer to execute a process, comprising:
acquiring a weight of a blend shape model to be blended with a base model as a blend shape parameter;
acquiring a magnitude of a correction factor that affects an expression of the blend shape model as a correction parameter; and
correcting a transformation between the base model and the blend shape model on the basis of a correction equation associated with the correction factor and the blend shape model and generating a face of a character using the transformation corrected, the blend shape parameter, and the correction parameter.

11. A user interface comprising:
a blend shape parameter input field where a list of a plurality of expression models is displayed;
a correction parameter input field where a list of a plurality of model factors is displayed; and
a preview area where a face of a character is displayed, the face being generated on the basis of at least one expression model selected in the blend shape parameter input field and at least one model factor selected in the correction parameter input field, wherein
each of the plurality of model factors affects an expression of at least one expression model among the plurality of expression models, and at least one expression model whose expression is affected by the at least one model factor selected in the correction parameter input field among the plurality of expression models displayed in the blend shape parameter input field is highlighted.

12. The user interface according to claim 11, further comprising:
a blend shape model selection field where a list of a plurality of blend shape models is displayed;
a correction factor input field where a correction factor is input; and
an edit area where a face of the character is displayed, the face being generated on the basis of one blend shape model selected in the blend shape model selection field and the correction factor input to the correction factor input field and where a user is allowed to deform the face by individually shifting a specific vertex, side, or plane of a polygon mesh of which the face is formed, wherein
the correction factor affects an expression of at least one blend shape model among the plurality of blend shape models, and at least one blend shape model whose expression is affected by the correction factor input to the correction factor input field among the plurality of blend shape models displayed in the blend shape model selection field is highlighted.
